(19) United States
(12) Patent Application Publication
(10) Pub. No.: US 2017/0184475 A1
(43) Pub. Date: Jun. 29, 2017

(54) MICROBIAL SAMPLING SYSTEM

(71) Applicant: Venturedyne, Ltd., Pewaukee, WI (US)

(72) Inventors: David L. Chandler, Highland, CA (US); Otto Johansen, Yucaipa, CA (US); Nguyen T. Tran, Redlands, CA (US)

(21) Appl. No.: 15/388,651

(22) Filed: Dec. 22, 2016

Related U.S. Application Data
(60) Provisional application No. 62/272,472, filed on Dec. 29, 2015.

(51) Int. Cl. G01N 1/24

(52) U.S. Cl. CPC G01N 1/24

(57) ABSTRACT

A microbial gaseous-fluid sampler for collecting microbial particles from gaseous fluid includes a gaseous-fluid intake portion having a sample head with a plurality of holes. The gaseous-fluid intake portion further includes a collar configured to receive a Petri dish including agar. The plurality of holes define an exit plane that is positioned a distance from the agar within a range of 5.5 millimeters to 7.5 millimeters. The velocity of the air exiting the plurality to holes is within a range of 18.5 meters per second to 20.5 meters per second.

### CROSS-REFERENCE TO RELATED APPLICATIONS

This application claims priority to co-pending U.S. Provisional Patent Application No. 62/272,472, filed on Dec. 29, 2015, the entire contents of which are incorporated herein by reference.

### BACKGROUND

The invention relates to microbial gaseous-fluid sampler and methods of operating the same. Microbial samplers are used, for example, to monitor for the presence of airborne microorganisms in controlled environments where contamination of a product being manufactured can render that product unsuitable for its intended purpose. As an example, pharmaceutical manufacturers maintain controlled environments and operate with procedures that reduce the risk of biological contamination. These environments where pharmaceutical products are formulated and packaged are regulated by government agencies to insure compliance to standards that specify a maximum number of viable organisms allowed to be present in a given volume of air collected from within the controlled environment.

One category of microbial samplers uses an impaction method, in which a known volume of air is drawn into the microbial sampler. Commonly, such microbial gaseous-fluid samplers are operable to capture bacteria, fungi, and other particles onto a Petri dish loaded with nutrient agar. After the given volume of air is sampled, the Petri dish is incubated and the microorganisms that are deposited on the agar and that are viable will form colonies. The colonies formed after incubation are counted to determine the concentration of colony forming units (CFU's). The number of CFU's is then compared to the allowable limit applicable to the process being performed.

### SUMMARY

In one aspect, the invention provides a microbial gaseous-fluid sampler for collecting microbial particles from gaseous fluid. The sampler includes a gaseous-fluid intake portion having a sample head with a plurality of holes. The gaseous-fluid intake portion further includes a collar configured to receive a Petri dish including agar. The plurality of holes define an exit plane that is positioned a distance from the agar within a range of 5.5 millimeters to 7.5 millimeters. The velocity of the air exiting the plurality of holes is within a range of 18.5 meters per second to 20. 5 meters per second.

In another aspect, the invention provides an intake portion for a microbial gaseous-fluid sampler. The intake portion includes a sample head with a plurality of holes arranged in a grid with separation between adjacent holes measuring within a range of 0.12 inches to 0.13 inches. The intake portion further includes a collar selectively interlocked with the sample head. The collar is configured to receive a Petri dish including agar. The plurality of holes define an exit plane that is positioned a distance from the agar within a range of 5.5 millimeters to 7.5 millimeters. The velocity of the air exiting the plurality to holes is within a range of 18.5 meters per second to 20.5 meters per second.

Other aspects of the invention will become apparent by consideration of the detailed description and accompanying drawings.

### BRIEF DESCRIPTION OF THE DRAWINGS

FIG. 1 is a perspective view of a conventional portable gaseous-fluid sampler including an intake portion.

FIG. 2 is perspective view of an intake portion embodying the invention.

FIG. 3 is an exploded view of the intake portion of FIG. 2.

FIG. 4 is another exploded view of the intake portion of FIG. 2.

FIG. 5 is a bottom view of a sample head of the intake portion of FIG. 2.

FIG. 6 is a perspective view of a cross-section of the intake portion of FIG. 2.

FIG. 7 is a cross-sectional view of the intake portion of FIG. 2.

FIG. 8 is a perspective view of an intake portion according to another embodiment of the invention.

FIG. 9 is an exploded view of the intake portion of FIG. 8.

FIG. 10 is a perspective view of a cross-section of the intake portion of FIG. 8.

FIG. 11 is a cross-sectional view of the intake portion of FIG. 8.

FIG. 12 is a schematic illustrating the conventional impaction method for biological collection with A) low impaction velocity, B) critical impaction velocity, and C) high impaction velocity.

FIG. 13 is graph of measured physical collection efficiency for 1 μm and 5 μm as a function of the distance between an exit plane defined by a plurality of holes formed in a sample head and an agar contained within a Petri dish.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

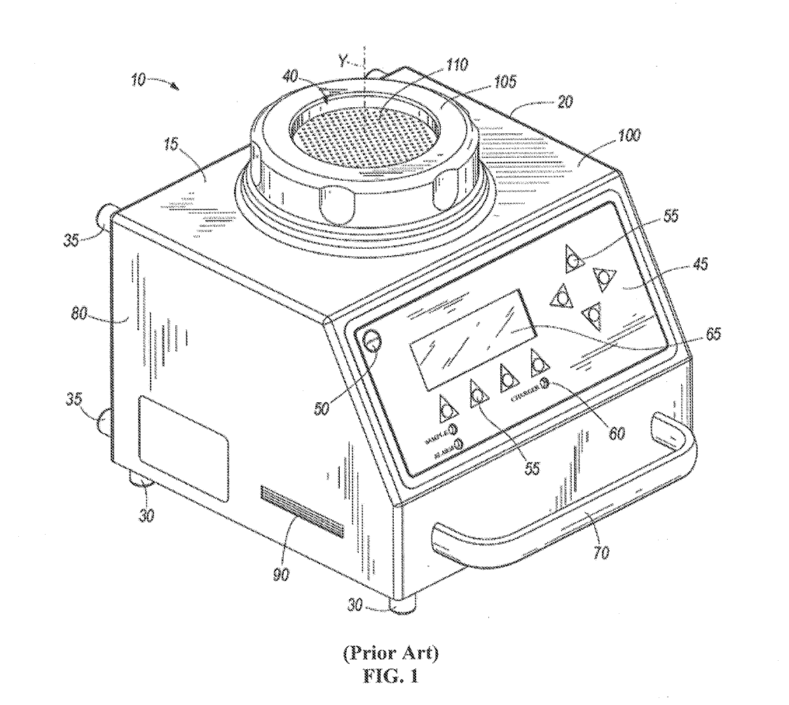

FIG. 1 illustrates a conventional portable gaseous-fluid sampler 10 operable to collect microbial particles from a gaseous fluid. It is to be understood that microbial particles can include biologically active particles such as bacteria, fungi, and similar particles. Moreover, the term gaseous fluid makes reference to ambient air and other gaseous fluid that may not be considered as ambient air, such as, but not limited to, air in a clean room environment.

With reference to FIG. 1, the portable sampler 10 includes a support structure, such as a housing 15, which may be divided into a top cover 20 and a bottom cover. However, the structure does not need to be the housing 15. Rather, the structure can be an open structure for supporting the gaseous-fluid flow system. The portable sampler 10 also includes a first set of supports 30 and a second set of supports 35. The first set of supports 30 helps the portable sampler 10 sit in a first orientation, which is shown in FIG. 1, defining a gaseous fluid intake portion 40 facing upward. The second set of supports 35 helps the portable sampler 10 sit in a second orientation (not shown) defining the intake portion 40 facing sideways. The just-described orientations are relative to the position of the portable sampler 10 within the figures. It is to be understood that the portable sampler 10 may operate at any orientation or angle of the intake portion 40 and need not to be supported by the first set of supports 30 or the second set of supports 35. For example, the portable sampler 10 can include a tripod mount (not shown) to set the portable sampler 10 at an elevated position.

The portable sampler 10 also includes an interface panel 45 for a user to operate the portable sampler 10 and to view information related to the portable sampler 10 and the samples collected by the portable sampler 10. The interface panel 45 includes a power button 50 generally configured to operate the portable sampler 10 between an “on” state and an “off” state. Depending on the configuration of the portable sampler 10, the power button 50 may operate the portable sampler 10 between other states, such as an “idle” state and a “power save” state. The interface panel 45 also includes buttons 55 operable to control other operating characteristics of the portable sampler 10, and LED lights 60 indicating, among other things, when the portable sampler 10 is in an “alarm” mode or when a sample has been collected. The LED lights 60 may be operable to indicate other modes or states of the portable sampler 10. The interface panel 45 also includes an LCD display 65 operable to display information related to the portable sampler 10 and the sample collected by the portable sampler 10. Other constructions of the portable sampler 10 can include different types of displays other than the LCD display 65. Moreover, other constructions of the portable sampler 10 can include different configurations for the interface panel 45.

In the construction shown in FIG. 1, the portable sampler 10 includes a handle 70 mounted to the housing 15. The handle allows a user to transport the portable sampler 10 between different locations. Also shown in FIG. 1, the first side panel 80 includes a printer slot 90, which discharges printed product (e.g., a label) from a printer unit. The printer slot 90 may be located at a different location of the housing 15 based of the configuration of the portable sampler 10.

The intake portion 40 shown in FIG. 1 is centrally located on a top panel 100 of the housing 15. The intake portion 40 in FIG. 1 includes a sample head (i.e., a lid or cover) 105 having a centrally located porous surface 110 that allows the flow of a gaseous fluid. The elements of the intake portion 40 define a substantially circular shape and are positioned concentric with respect to a vertical axis Y centered on the top panel 100.

U.S. Pat. No. 7,752,930, the entire content of which is incorporated herein by reference, disclose in detail example configurations of a control system and a gaseous-fluid flow system that create an airflow through the porous surface 110 of the intake portion 40 during operation. Generally, gaseous-fluid flow is generated by operating a blower assembly, which causes gaseous fluid to be sucked into the portable sampler 10 through the apertures defined by the cover 105. The configuration of the cover 105 causes gaseous fluid to engage a contact device (e.g., a Petri dish) in a direction substantially parallel to the axis Y. As explained further below, the contact device, generally supporting some type of nutrient agar, is allowed to receive or capture biologically active particles present in the gaseous fluid. Subsequently, gaseous-fluid flow continues from the surface of the contact device to the blower assembly and ultimately to an exhaust.

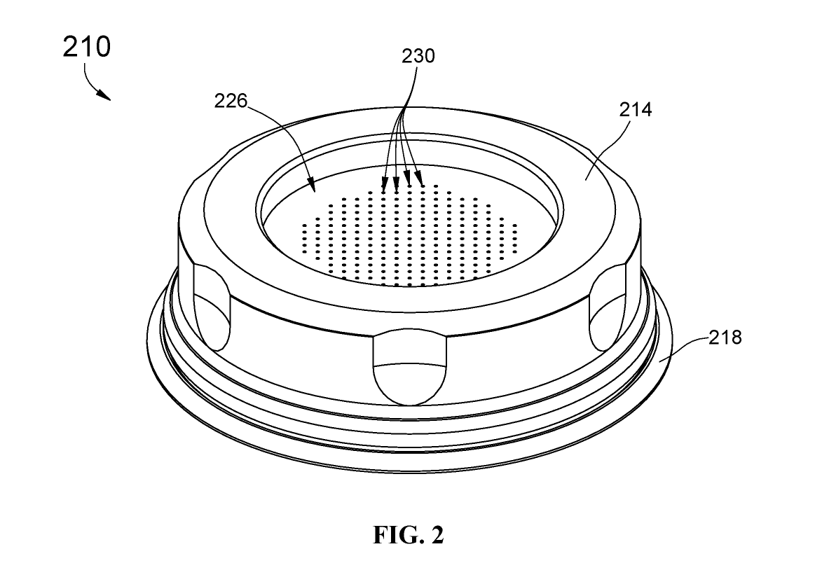

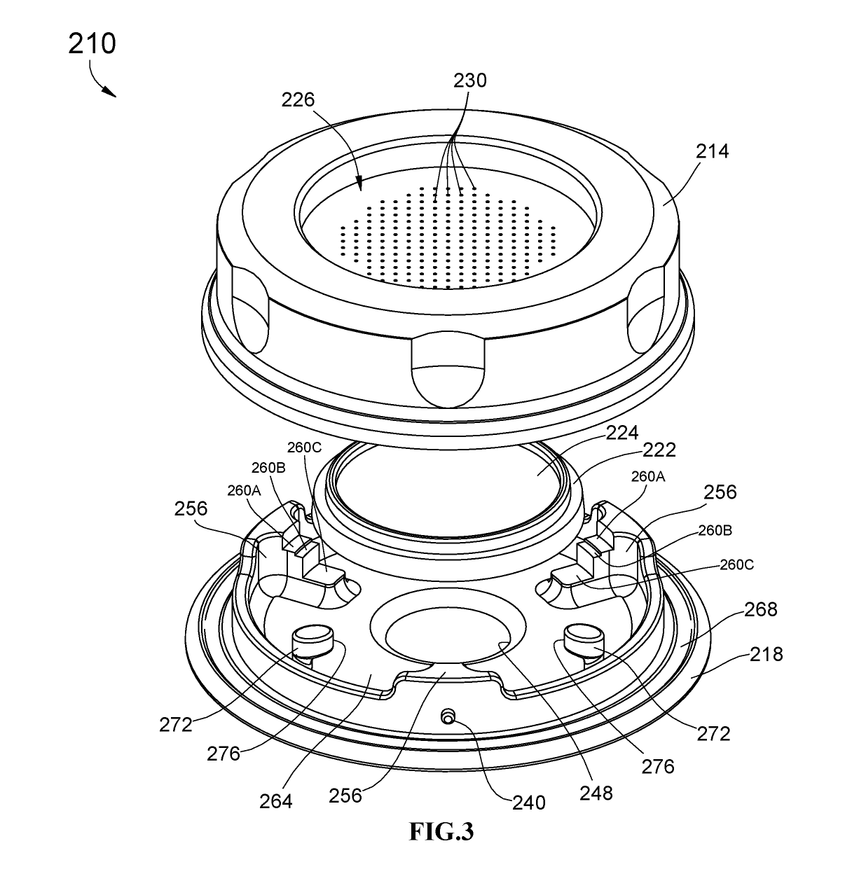

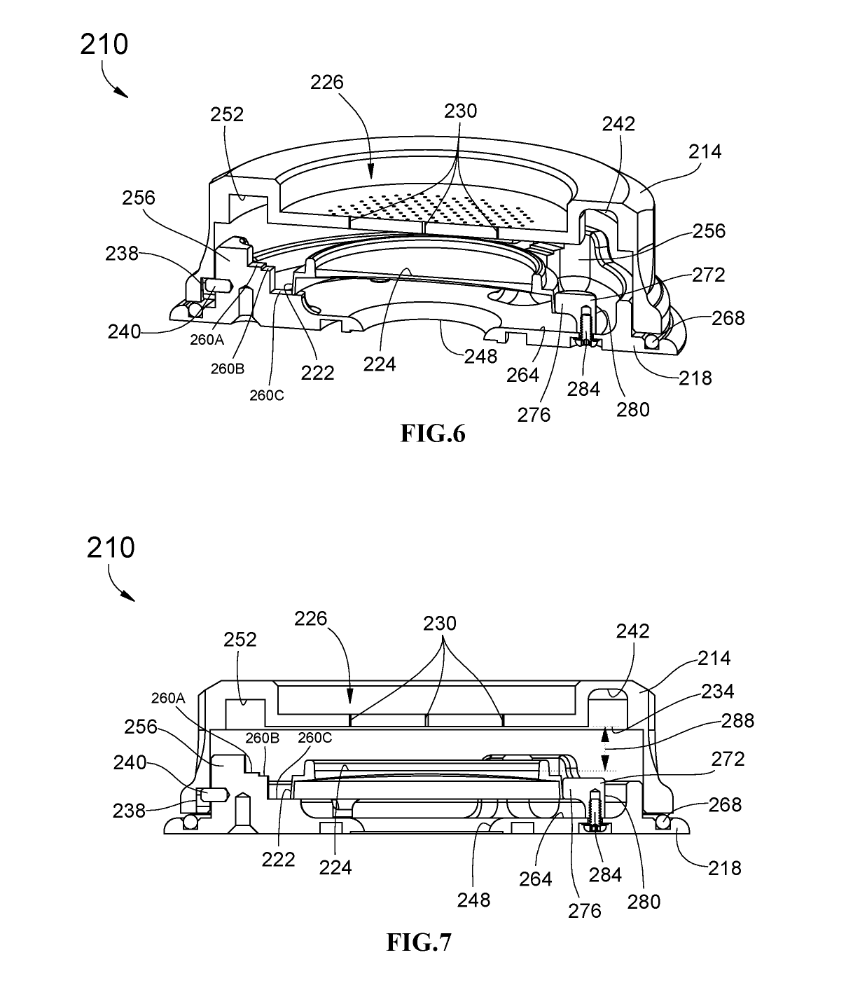

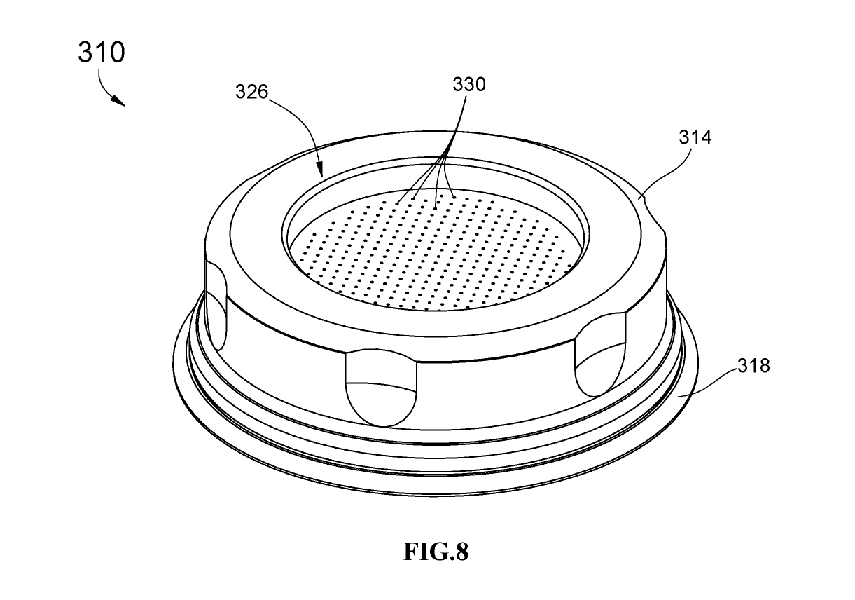

The improvement over the design shown in FIG. 1 is shown in FIGS. 2-7 according to one embodiment of the invention and FIGS. 8-11 according to another embodiment of the invention. With reference to FIGS. 2-7, an intake portion 210 for use with the portable sampler 10 of FIG. 1 is shown. The intake portion 210 is intended to replace the intake portion 40 of the conventional sampler 10 described above and shown in FIG. 1. As shown in FIG. 3, the intake portion 210 includes a sample head 214 (i.e., a cover or lid), a mounting collar 218, and a contact device 222 (e.g., a Petri dish). As explained in greater detail below and with reference to FIGS. 3 and 6, the Petri dish 222 is supported within the mounting collar 218 and the sample head 214 is secured to the mounting collar 218, covering the Petri dish 222. The Petri dish 222 contains a nutrient agar 224 against which microorganisms that are contained within the air entering the intake portion 210 impact. The intake portion 210 shown in FIGS. 2-7 is only an exemplary construction, and it is to be understood that other physical appearances fall within the scope of the invention.

With reference to FIGS. 2-5, the sample head 214 includes a porous surface 226 having a plurality of holes 230 through which air from the surrounding environment containing microorganism passes. In the illustrated embodiment, the plurality of holes 230 includes 333 holes that are arranged in a grid with separation between adjacent holes measuring within a range of approximately 0.12 inches to approximately 0.13 inches (i.e., approximately 0.125 inches), with each of the plurality of holes 230 having a diameter within a range of approximately 0.022 inches to approximately 0.028 inches (i.e., approximately 0.0225 inches). In alternative embodiments, the plurality of holes 230 includes more or less than 333 holes and may be arranged in other suitable grid patterns. In some embodiments, the number of holes 230 is within a range of 200 holes to 340 holes. Additionally or alternatively, the plurality of holes are configured as slots. In other words, the term “holes” generically refers to apertures, circles, ovals, slots, etc. In the illustrated embodiment, the sample head 214 is form from a single piece of aluminum and hard anodized, and is further capable of being autoclaved for sterilization. With reference to FIG. 7, the plurality of holes 230 define an exit plane 234 from which the air passing through the sample head 214 exits the plurality of holes 230. In alternative embodiments, the sample head is fabricated from multiple parts including, for example, a disk with a plurality of holes formed therein and a ring for supporting the disk when secured to the mounting collar.

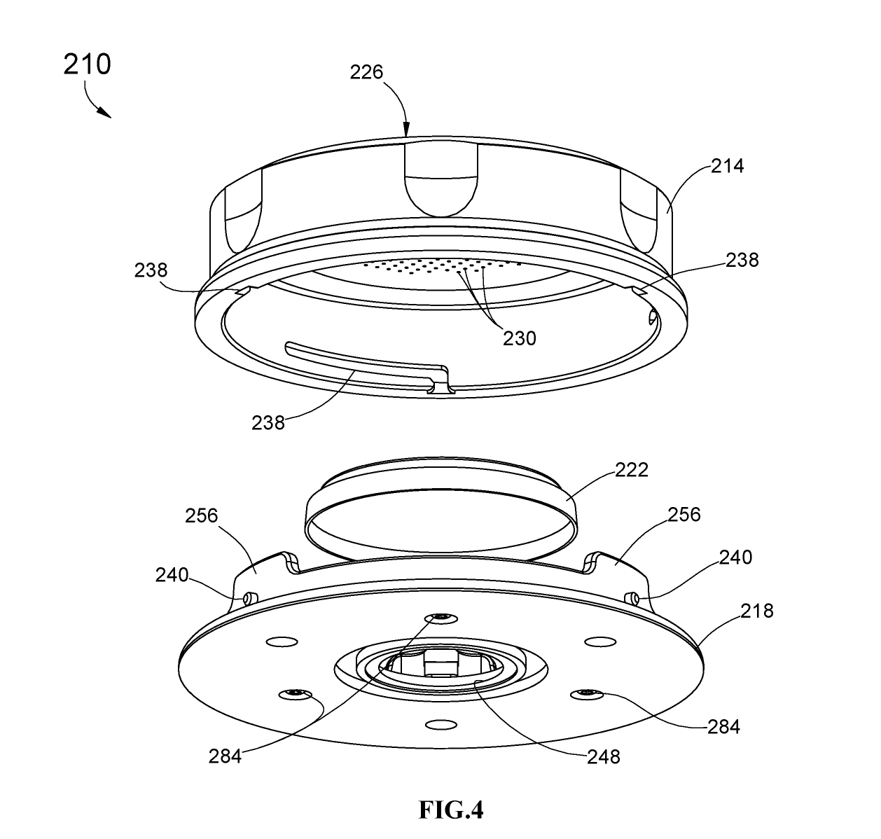

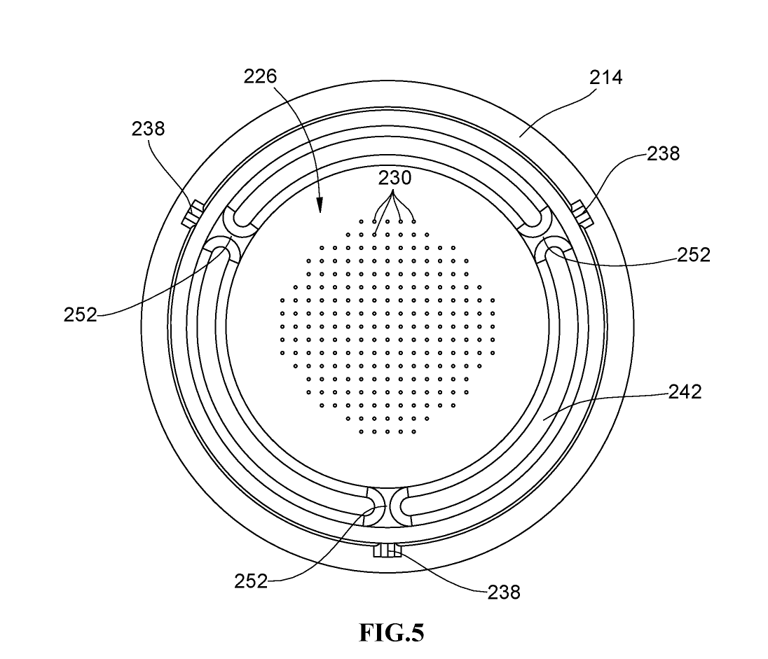

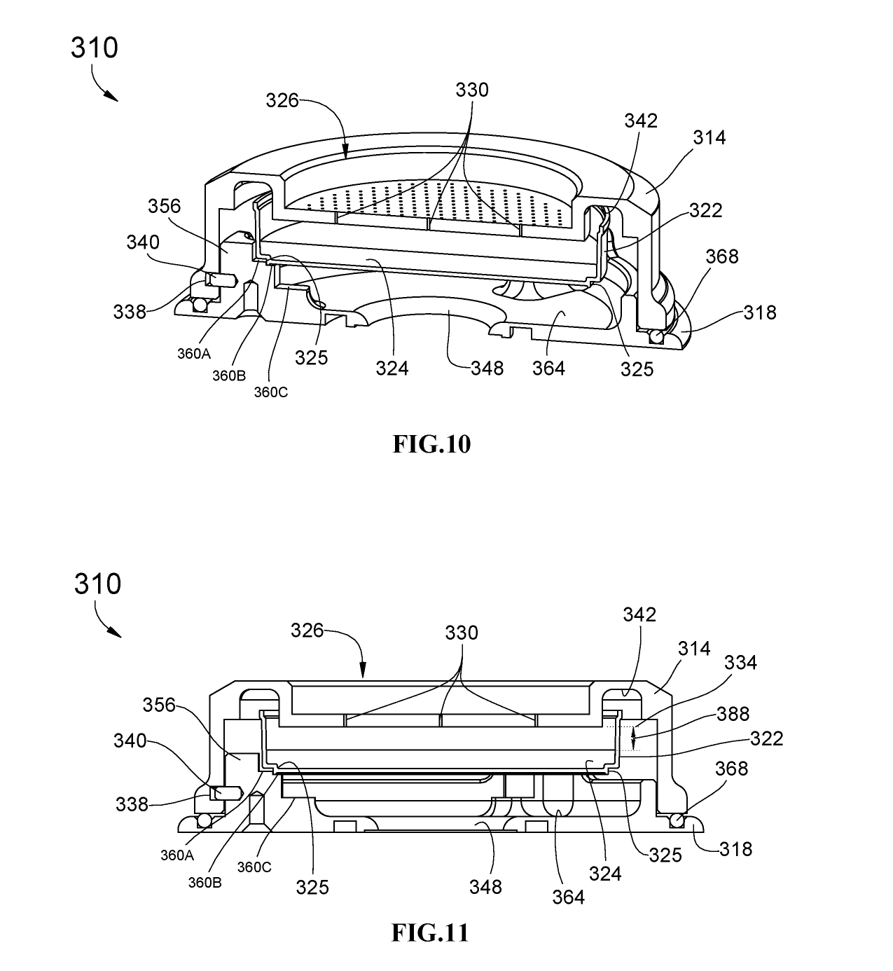

With reference to FIG. 4, the sample head 214 further includes three slots 238 configured to receive corresponding pins 240 positioned on the mounting collar 218 for locking the sample head 214 to the mounting collar 218. In particular, the sample head 214 and the mounting collar 218 are selectively interlocked with a bayonet-type connection by the pins 240 and slots 238. With reference to FIG. 5, the sample head 214 further includes a channel 242 in which air pass between the Petri dish 222 and an intake 248 formed in the mounting collar 218 (FIGS. 6 and 7). The intake 248 is in fluid communication with the vacuum source (i.e., blower assembly). A plurality of raised portions 252 are positioned in the channel 242 to retain and support the Petri dish 222 when sampling in a horizontal orientation. More specifically, the sample head 214 includes three raised portions 252 in the channel 242 that are in close proximity to the ridge of some larger Petri dishes positioned within the mounting collar 218 (such a larger Petri dish is illustrated in FIG. 10). The raised portions 252 serve to retain the Petri dish in position should the sampler be oriented with the sample head aimed to draw air in a horizontal direction rather than the more common vertical direction.

With reference to FIG. 3, the mounting collar 218 includes three pedestals 256 with ledges at various heights. In the illustrated embodiment, each pedestal 256 includes three ledges 260A, 260B, and 260C at different heights from a bottom 264 of the mounting collar 218. Specifically, the ledge 260A is the highest from (i.e., furthest from) the bottom 264 and the ledge 260C is the lowest from (i.e., closest to) the bottom 264. In the illustrated embodiment, the Petri dish 222 is a RODAC dish with a diameter of approximately 54 millimeters and is supported on the lowest ledge 260C. The ledge 260A is provided to support an alternative Petri dish with a larger diameter (e.g., 90 millimeters). In general, the mounting collar 218 includes a pedestal 256 with a plurality of ledges 260A-260C to position a Petri dish at a center of the plurality of holes 230 and at the desired distance from the plurality holes 230, as discussed further below. In some embodiments, the plurality of holes in the sample head are arranged in a pattern such that every hole is positioned over some portion of the agar.

In the illustrated embodiment, an O-ring 268 is positioned between the mounting collar 218 and the sample head 214 for improved sealing. Although in alternative embodiments, the O-ring may be omitted. The mounting collar 218 is a solid machined part fabricated from 316L stainless steel. There are no springs or visible fasteners to the user, which make it possible for the mounting collar 218 to be easily sanitized by an operator wiping it down with a cloth and antimicrobial disinfectant. In addition, the sample head 214 is formed as such to be cleaned with no inaccessible pockets that would prevent sanitation by wiping the visible surfaces.

With continued reference to FIG. 3, three adjustable retainers 272 are provided on the mounting collar 218. As shown in FIG. 6, the adjustable retainers 272 includes a blocking portion 276, a stem portion 280, and a fastener 284 to secure the stem portion 280 to the mounting collar 218. The blocking portion 276 of the adjustable retainer 272 is abutted against the Petri dish 222 to retain the Petri dish 222 within the mounting collar 218. In particular, the adjustable retainers 272 are particularly suited for retaining smaller-diameter Petri dishes within the mounting collar 218. In the illustrated embodiment, the blocking portion 276 is an eccentric cam shape. Specifically, the position of the blocking portion 276 relative to the Petri dish 222 is adjustable relative to the Petri dish 222 by loosening of the fastener 284 and movement of the blocking portion 276 by a user. The adjustable retainers 272 allow for Petri dishes of different sizes to be supported within the same mounting collar 218. In other words, the mounting collar 218 includes an adjustable retainer 272 to position a Petri dish at a center of the plurality of holes 230 that is adjustable to accommodate Petri dishes of various sizes.

With reference to FIG. 7, the plurality of holes 230 are positioned a distance 288 from the agar 224 contained within the Petri dish 222 within a range of approximately 5.5 millimeters to approximately 7.5 millimeters. In particular, the distance 288 is measured from the exit plane 234 that is defined by the plurality of holes 230 to the agar 224. The velocity of the air exiting the plurality to holes 230 is within a range of approximately 18.5 meters per second to approximately 20.5 meters per second. In a preferred embodiment, the distance 288 between the exit plane 234 and the agar 224 is within a range of approximately 6 millimeters to approximately 7 millimeters (i.e., approximately 6.5 millimeters), and the velocity of air exiting the plurality of holes 230 is within a range of approximately 19 meters per second to approximately 20 meters per second (i.e., approximately 19.5 meters per second). The volumetric air flow rate passing through the plurality of holes 230 is within a range of approximately 90 liters per minute to approximately 110 liters per minute (i.e., approximately 100 liters per minute (LPM)). In alternative embodiments, the volumetric air flow rate passing through the plurality of holes is within a range of approximately 0.9 cubic feet per minute to approximately 1.1 cubic feet per minute (i.e., approximately 1 cubic foot per minute). In further alternatives, the volumetric air flow rate passing through the plurality of holes is within a range of approximately 22.5 liters per minute to approximately 27.5 liters per minute (i.e., approximately 25 liters per minute).

As explained further below, in some embodiments the invention provides for the critical combination of the distance 288 falling with the range of approximately 5.5 to 7.5 mm and the air velocity within the range of approximately 18.5 to 20.5 m/s to achieve unexpected improvements in the biological collection efficiency of the sampler utilizing the intake portion 210. In other words, the range of the distance 288 between the plurality of holes 230 and the agar 224 in combination with the air velocity significantly improves the efficiency of the sampler to collect biological specimens.

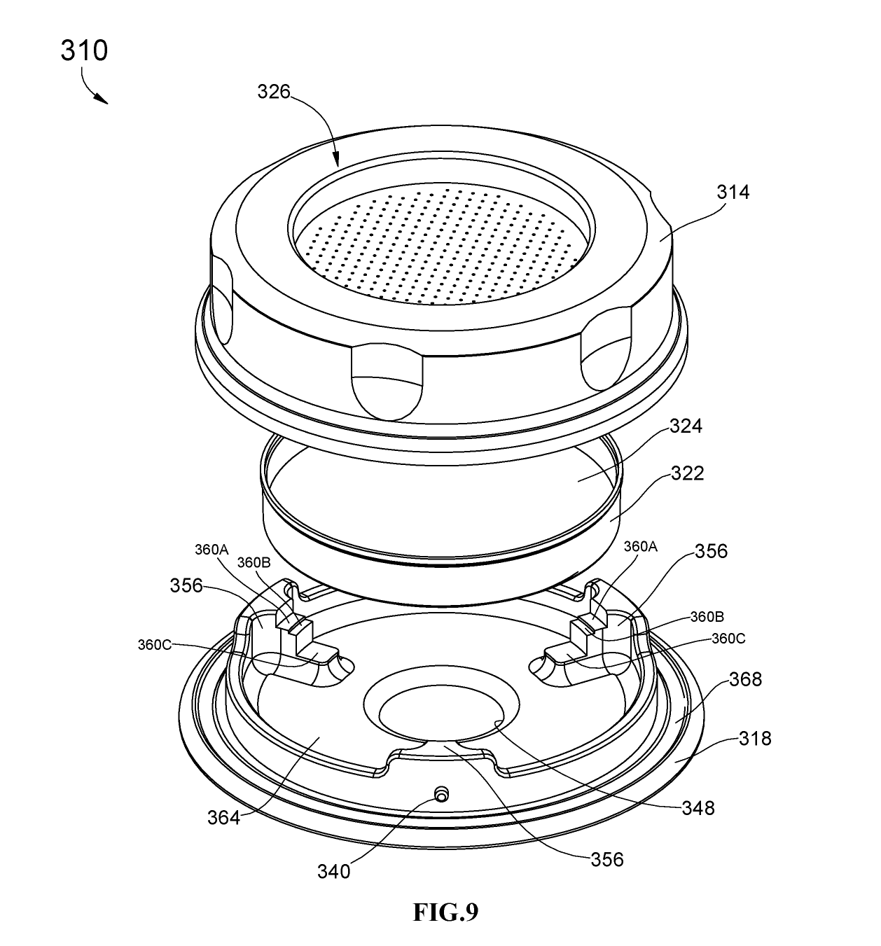

With reference to FIGS. 8-11, an intake portion 310 for use with the portable sampler 10 of FIG. 1 according to an alternative embodiment of the invention is shown. The intake portion 310 is intended to replace the intake portion 40 of the conventional sampler 10 described above and shown in FIG. 1. The intake portion 310 (FIGS. 8-11) is similar to the intake portion 240 (FIGS. 2-7) and only the differences are described below with similar components referenced with similar references numerals plus 100. As shown in FIG. 9, the intake portion 310 includes a sample head (i.e., a cover or lid) 314, a mounting collar 318, and a Petri dish 322 containing agar 324. As explained in greater detail below, the Petri dish 322 is supported within the mounting collar 318 and the sample head 314 is secured to the mounting collar 318, covering the Petri dish 322. In the embodiment illustrated in FIGS. 8-11, there are no adjustable retainers. The Petri dish 322 is a larger diameter (e.g., 90 millimeters) and includes a lower lip 325 commonly provided on Petri dishes for stacking purposes. A middle ledge 360B on pedestals 356 support the lower lip 325 formed on the bottom of the Petri dish 322 (FIGS. 10 and 11).

The ability of a microbial sampler to collect microbes entrained in the sampled air can be measured by two main factors that are a function of impact velocity. Firstly, the impact velocity should be high enough to allow for the entrapment of viable particles down to approximately 1 μm. Secondly, the impact velocity should be low enough to ensure viability of particles by avoiding mechanical damage or the breakup of clumps of bacteria or micromycetes. In other words, the impact velocity of the air hitting the agar is a compromise between optimizing the two competing factors. See ISO standard 14698-1:2003(E).

The discussion presented below illustrates how in some embodiments of the invention the critical range of the distance 288 and the air velocity in the invention was unexpected since it conflicted with teachings common in the art.

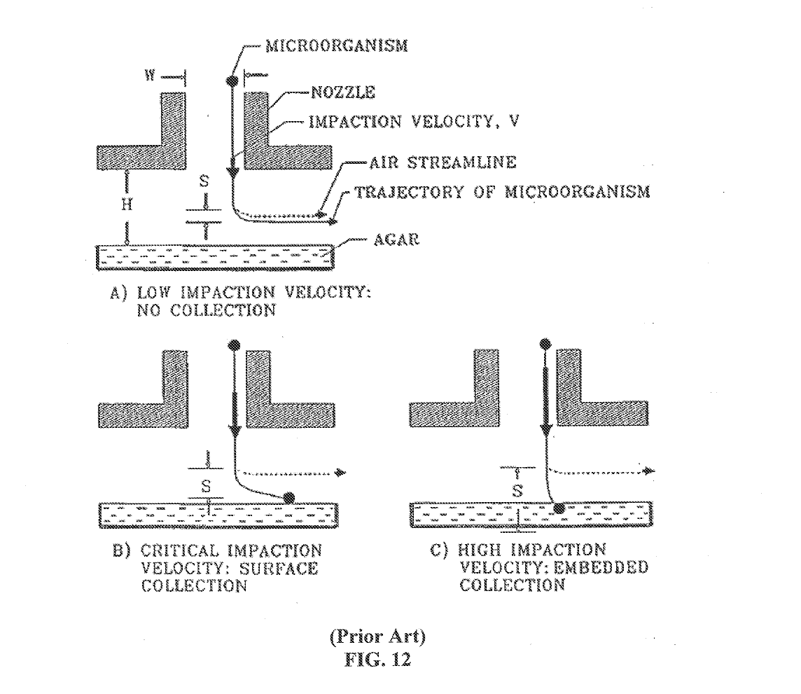

Conventional microbial samplers that use the impaction method, employ a vacuum source such as a fan or blower that is built into the microbial sampler or an external vacuum source. The purpose of the vacuum source is to drawn a known volume of air (e.g., a cubic meter) through the sampling system at a known rate. The air enters the plurality of holes in a direction perpendicular to the agar. With the proper air velocity, the particles entrained in the air are impacted onto the agar as the air abruptly changes direction to flow around the Petri dish. Without the proper air velocity, the particles may continue their trajectory with the main airflow. FIGS. 12A-12C illustrates the conventional impaction method of collecting microorganisms on agar. In particular, FIGS. 12A-12C illustrate how the impaction of the microorganism changes at low impaction velocity (FIG. 12A), critical impaction velocity (FIG. 12B), and high impaction velocity (FIG. 12C). In general, if the air velocity is too low, the microorganism does not impact the agar, but rather continues with the air streamline around the agar (FIG. 12A). If the air velocity is too high, the microorganism becomes embedded within the agar and may be destroyed upon impact, thus not resulting in a colony forming upon incubation.

Testing the physical and biological collection efficiency of biological samplers requires specialized equipment and expertise. To make do without either the equipment or expertise, designers and manufacturers of biological samplers have traditionally applied theory to produce a variety of samplers. Independent third party studies have followed, which revealed that the actual performance of most samplers deviates unfavorably compared to the performance specified by the manufacturers. Evidence of the conventional designs having inferior performance is provided by, for example, Table 7 from the study of “Characteristics of Twenty-Nine Aerosol Samplers Tested at U.S. Army Edgewood Chemical Biological Center” (2000-2006).

Studies have also shown that calculations for predicting the performance of impactors using models of single jets and impact plates vary from the empirical results obtained on instruments that are designed with multiple jets. Evidence of this is provided by, for example, page 595 of the “Investigation of Cut-Off Sizes and Collection Efficiencies of Portable Microbial Samplers” (June 2006). In general, the study finds in most cases that the theoretical cut-off size (i.e., the size of particles too small for collection by the sampler) was lower than the experimental value. In other words, the theory incorrectly predicts the sampler is able to collect particles smaller than what is realistically achievable by the sampler.

The international standard, ISO 14698-1:2003 (E) establishes the principles and methodology for assessing biocontamination when cleanroom technology is applied for sterile manufacturing. The standard describes a testing technique, given as informative guidance and states that microbial sampler should have an impact velocity high enough to allow the entrapment of viable particles down to approximately 1 um and low enough to ensure viability of particles by avoiding mechanical damage.

The following series of tests were performed as part of arriving at the invention, with deviations from conventional teachings detailed.

Test 1—Determining Physical Collection Efficiency

Given the uncertainty of results when relying solely on theoretical engineering design choices, the physical collection efficiency was experimentally tested as a function of the distance between the sample head and the agar while the jet velocity is constant. Two different particle sizes of interest were used: 1 μm and 5 μm. For this test the jet velocity was held constant at 12.5 meters per second and a conventional sample head was used with 333 holes, each with a diameter of 0.028 inches arranged in a grid with a separation of 0.125 inches. The particles in the challenge aerosol were generated using a vibrating orifice aerosol generator to produce droplets of a saline solution of a known volume. The droplets yield salt particles of a known diameter when the liquid portion of the droplet evaporates.

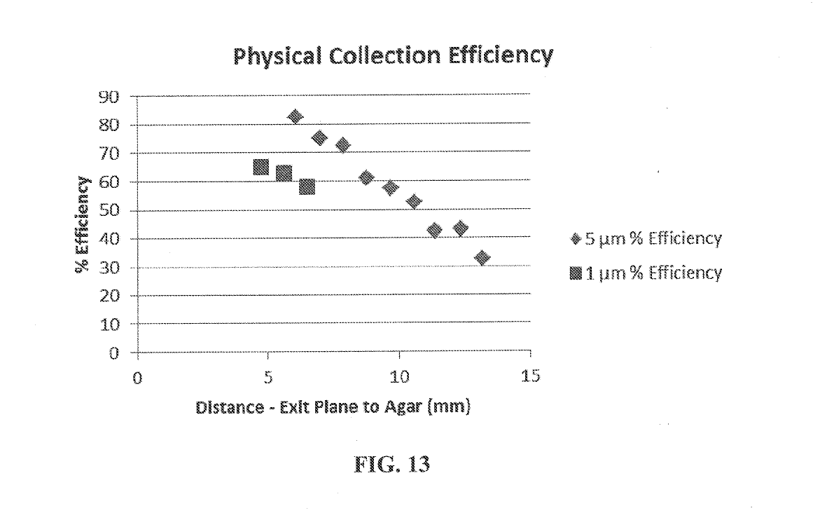

With reference to FIG. 13, the test illustrated that the measured physical collection efficiency improved as the distance between the exit plane of the plurality of holes in the sample head and the surface of the agar was decreased. The test also indicated that the physical collection efficiency for 1 μm salt particles would be less than 50% when the distance from the exit plane to the agar was greater than 7 millimeters. However, testing at large distances yielded data that was not reproducible and could only be successfully reproduced up to a distance of 6.5 millimeters. Prefilled Petri dishes, which are commonly filled with 25 ml of agar to a depth of 4.45 mm produce a distance between the exist plane of the holes to the agar surface of 10.5 mm. However, increasing the physical collection efficiency by increasing impaction velocity or by decreasing the distance, could adversely affect the biological collection efficiency.

Test 2—Determining Biological Collection Efficiency

The next step of testing, after the physical collection efficiency, is to determine the biological collection efficiency. A bacterium, Staphylococcus saprophyticus, having a diameter of 0.6 to 1.4 μm was used as a challenge aerosol. A biological sampler using liquid impingement collection method and having an independently certified collection efficiency of 100% was used as a reference.

The sampler operates with a volumetric air flow rate passing through the plurality of holes of 100 liters per minute (LPM). For this test, the air velocity remained at 12.5 m/s and the distance was set to 9.18 millimeters, and resulted in a measured biological collection efficiency of 83%, which was better than expected since the biological collection efficiency exceeded the physical collection efficiency measured for the 1μm particles (see FIG. 13). The biological collection efficiency being larger than the physical collection efficiency was attributed to the higher density of the bacterium particle itself, compared to that of the salt used in the physical collection test.

Conventional teachings provided by “Effect of Impact Stress on Microbial Recovery on an Agar Surface” (1995) states that when the height between the impaction surface and the nozzle plane is larger than the width of the nozzle, the collection cutoff size is only moderately affected by variations in distance. This study also reported an injury rate for of 31±19% and 39±14 for P. fluorescens and M. luteus, respectively, when using an impaction velocity of 24 m/s.

The higher biological collection efficiency from Test 2 was in contrast with conventional theory since in order to achieve an 83% biological collection efficiency with an expected physical collection efficiency of less than 83%, the injury rate would have had to be negligible. This led to the discovery from the biological collection efficiency test that the microbes were not being injured at a measurable rate. The lower than expected injury percentage is attributed to the lower impaction velocity of initial designs (12.5 m/s) compared to the lowest velocity used in the study noted above (24 m/s).

Test 3—Reducing the Distance Between the Hole Exit Plane to the Agar

With the strong positive affect that the distance had on the 5 μm physical collection efficiency and the higher than expected biological collection efficiency, the next step was to conducted an experiment to measure the biological collection efficiency with the same velocity (i.e., 12.5 m/s) while reducing the distance from 9.19 mm to 6.5 mm. The biological collection efficiency increased from 83% to 96% with the reduction in the distance to 6.5 mm. This result contradicted the theoretical prediction for physical collection efficiency which predicted only a moderate affect for the variation of the distance. This result also indicated that the reduced distance did not adversely affect the viability of the microbes impacting the agar.

Test 4—Reducing Hole Diameter to Increase Impaction Velocity

The next test utilized the intake portion 210 according to an embodiment of the invention with the sample head 214 having the plurality of holes 230 with a diameter of 0.0225 inches, which produced an impaction velocity of 19.5 meters per second and kept the distance 288 to 6.5 mm. Testing of the invention showed the biological collection efficiency increased to 101%. Although it is theoretically impossible to achieve efficiency greater than 100%, the difference can be attributed to the flow rate tolerances of ±2% applicable to both the reference sampler and the unit under test. This test result again contradicted the conventional teachings that predicted a higher injury percentage for higher impaction velocities. Granted, the impaction velocity for Test 4 was still lower (19.5 m/s) than the lowest impaction velocity in the published study referenced above (24 m/s).

In view of the above, some embodiments of the invention provide the combination of the critical distance 288 and the air velocity in the intake portions 210 and 310 that unexpectedly improved the biological collection efficiency. This improvement in the performance of the microbial sampler has not been accomplished previously by the application of theoretical engineering design choices applied in other microbial samplers currently on the market.

What is claimed is:

1. A microbial gaseous-fluid sampler for collecting microbial particles from gaseous fluid comprising:
a gaseous-fluid intake portion having a sample head with a plurality of holes, the gaseous-fluid intake portion further includes a collar configured to receive a Petri dish including agar;
wherein the plurality of holes define an exit plane that is positioned a distance from the agar within a range of 5.5 millimeters to 7.5 millimeters, and wherein the velocity of the air exiting the plurality of holes is within a range of 18.5 meters per second to 20.5 meters per second.

2. The microbial gaseous-fluid sampler of claim 1, wherein the distance between the exit plane and the agar is within a range of 6 millimeters to 7 millimeters.

3. The microbial gaseous-fluid sampler of claim 1, wherein the velocity of air exiting the plurality of holes is within a range of 19 meters per second to 20 meters per second.

4. The microbial gaseous-fluid sampler of claim 1, wherein a volumetric air flow rate passing through the plurality of holes is within a range of 90 liters per minute to 110 liters per minute.

5. The microbial gaseous-fluid sampler of claim 1, wherein a volumetric air flow rate passing through the plurality of holes is within a range of 0.9 cubic feet per minute to 1.1 cubic feet per minute.

6. The microbial gaseous-fluid sampler of claim 1, wherein a volumetric air flow rate passing through the plurality of holes is within a range of 22.5 liters per minute to 27.5 liters per minute.

7. The microbial gaseous-fluid sampler of claim 1, wherein each of the plurality of holes has a diameter within a range of 0.022 inches to 0.028 inches.

8. The microbial gaseous-fluid sampler of claim 1, wherein the plurality of holes includes between 200 holes and 340 holes.

9. The microbial gaseous-fluid sampler of claim 1, wherein the plurality of holes are arranged in a grid with separation between adjacent holes measuring within a range of 0.12 inches to 0.13 inches.

10. The microbial gaseous-fluid sampler of claim 1, wherein the collar includes an adjustable retainer to position the Petri dish at a center of the plurality of holes.

11. The microbial gaseous-fluid sampler of claim 1, wherein the collar may include a pedestal with a plurality of ledges to position the Petri dish at a center of the plurality of holes

12. The microbial gaseous-fluid sampler of claim 1, further comprising an O-ring positioned between the collar and the sample head.

13. The microbial gaseous-fluid sampler of claim 1, wherein the sample head is formed from a single piece of aluminum.

14. The microbial gaseous-fluid sampler of claim 1, wherein the sample head is autoclaved for sterilization.

15. The microbial gaseous-fluid sampler of claim 1, wherein the sample head includes a channel for air to pass between the Petri dish and an intake formed in the mounting collar.

16. The microbial gaseous-fluid sampler of claim 15, wherein a plurality of raised portions are positioned in the channel to retain the Petri dish when sampling in horizontal orientation.

17. The microbial gaseous-fluid sampler of claim 1, wherein the plurality of holes include a plurality of slots.

18. The microbial gaseous-fluid sampler of claim 1, wherein the sample head and the collar are selectively interlocked with a bayonet-type connection.

19. The microbial gaseous-fluid sampler of claim 1, wherein each of the plurality of holes is positioned over a portion of the agar in the Petri dish.

20. An intake portion for a microbial gaseous-fluid sampler, the intake portion comprising:
a sample head with a plurality of holes arranged in a grid with separation between adjacent holes measuring within a range of 0.12 inches to 0.13 inches; and
a collar selectively interlocked with the sample head, the collar configured to receive a Petri dish including agar;
wherein the plurality of holes define an exit plane that is positioned a distance from the agar within a range of 5.5 millimeters to 7.5 millimeters, and wherein the velocity of the air exiting the plurality to holes is within a range of 18.5 meters per second to 20.5 meters per second.
